(19) United States
(12) Patent Application Publication
(10) Pub. No.: US 2022/0055017 A1
(43) Pub. Date: Feb. 24, 2022

(54) CERIUM OXIDE PARTICLES AND METHOD FOR PRODUCTION THEREOF

(71) Applicant: RHODIA OPERATIONS, Aubervilliers (FR)

(72) Inventors: Naotaka OHTAKE, Tokushima Prefecture (JP); Kaoru NISHIMURA, Tokushima-Ken (JP); Toshihiro SASAKI, Tokushima Prefecture (JP); Mitsuhiro OKAZUMI, Tokushima Prefecture (JP)

(21) Appl. No.: 17/417,450

(22) PCT Filed: Dec. 19, 2019
(86) PCT No.: PCT/EP2019/086207

§ 371 Date: Jun. 23, 2021

(30) Foreign Application Priority Data
Dec. 28, 2018 (EP) 18306864.2

(51) Int. Cl. B01J 23/10; B01J 35/02; B01J 35/10; B01J 37/03; B01J 37/10; B01J 37/18; B01J 6/00

(52) U.S. Cl. CPC B01J 23/10; B01J 35/023; B01J 35/1014; B01J 35/1019; B01J 6/001; B01J 35/1028; B01J 37/031; B01J 37/10; B01J 37/18; B01J 35/1023

(57) ABSTRACT

The present invention relates to cerium oxide particles that have excellent heat resistance under hydrothermal conditions at high temperature. The present invention also relates to a method for preparing such cerium oxide particles and to a catalytic composition comprising said cerium oxide.

The present application claims the priority of European patent application EP 18306864 filed on 28 Dec. 2018, the content of which being entirely incorporated herein by reference for all purposes. In case of any incoherency between the present application and the EP application that would affect the clarity of a term or expression, it should be made reference to the present application only.

The present invention relates to cerium oxide particles that have excellent heat resistance under hydrothermal conditions at high temperature. The present invention also relates to a method for preparing such cerium oxide particles and to a catalytic composition comprising said cerium oxide.

### TECHNICAL BACKGROUND

Catalytic composition for purifying vehicle exhaust gas are composed of a catalytic metal such as platinum, palladium, or rhodium, and a co-catalyst for enhancing the catalytic action of such metal, both supported on a catalyst support made of, for example, alumina or cordierite. Cerium-oxide containing materials, such as cerium oxide, are usually used because they have the properties of absorbing oxygen under the oxidizing atmosphere and desorbing oxygen under the reducing atmosphere. It is most critical for activating the function of such cerium-oxide containing materials to keep the them at a high temperature. Low temperature of the exhaust gas, for example at engine start-up, will result in low purifying efficiency. Vehicle manufacturers are presently trying to solve this problem by placing the catalyst system close to the engine for introducing hot exhaust gas right after its emission from the engine into the catalyst system. There is also a need for materials that are efficient at lower temperatures.

In general, efficiency of exhaust gas treatment with a catalyst is proportional to the contact area between the active phase of the catalyst and the exhaust gas, and to the oxygen absorbing and desorbing capability of the cerium-oxide containing material. Thus the co-catalyst material is required to have a sufficiently large specific surface area and a sufficiently high oxygen absorbing and desorbing capability, a good heat resistance at high temperatures, as well as higher activity at lower temperatures.

For solving these problems, U.S. Pat. No. 7,361,322 B2 proposes a method for obtaining a cerium oxide having good heat resistance with a specific surface area higher than 30.0 m²/g after calcination at 900° C. for 5 hours, especially around 40-50 m²/g. WO 2016/075177 discloses cerium oxide particles exhibiting the following properties: a specific surface area comprised between 80 and 120 m²/g after calcination at 800° C. for 2 hours, under air; a specific surface area comprised between 55 and 80 m²/g after calcination at 900° C. for 5 hours, under air. WO 2017/198738 addresses the problem of resistance of cerium oxide under “hydrothermal” conditions at 700° C. These conditions are meant to mimick more closely the real conditions encountered by the material in the catalytic converter. WO 2017/198738 discloses indeed cerium oxide particles exhibiting a specific surface area comprised between 45 and 80 m²/g after calcination at 900° C. for 5 hours, under air; and a specific surface area comprised between 75 and 90 m²/g after ageing at 700° C. for 4 hours, under a gaseous atmosphere containing 10% by volume of O₂, 10% by volume of H₂O and the balance of N₂.

The present invention aims to address the problem of resistance to ageing in even more stringent conditions (700° C. or 800° C. for 16 hours, under a gaseous atmosphere containing 10% by volume of O₂, 10% by volume of H₂O and the balance of N₂). In the cited documents, there is no mention of the resistance to ageing under these stringent conditions.

### Definitions

It is specified that, in the continuation of the description, unless otherwise indicated, the values at the limits are included in the ranges of values which are given. This applies also to the expressions comprising “at least” or “at most”.

The term “specific surface area (BET)” is understood to mean the BET specific surface area determined by nitrogen adsorption. The specific surface area is well-known to the skilled person and is measured according to the Brunauer-Emmett-Teller method. This method was described in the periodical “The Journal of the American Chemical Society, 60, 309 (1938)”. The method used is also disclosed in standard ASTM D 3663-03 (reapproved 2008). In practice, the specific surface areas (BET) may be determined automatically with the appliance Flowsorb II 2300 or the appliance Tristar 3000 of Micromeritics according to the guidelines of the constructor. They may also be determined automatically with a Macsorb analyzer model 1-1220 of Mountech according to the guidelines of the constructor. Prior to the measurement, the samples are degassed under vacuum and by heating at a temperature of at most 200° C. to remove the adsorbed volatile species. More specific conditions may be found in the examples.

As usual in the field of oxides, the concentrations of the solutions of cerium are expressed in terms of CeO₂. See page 9 and the examples.

### DETAILS OF THE INVENTION

The present invention concerns cerium oxide particles as defined in one of claims 1 to 14.

The particles of the invention consist essentially of cerium oxide. Cerium oxide may be represented by formula CeO₂. The cerium oxide particles may comprise impurities such as residual nitrates or other rare-earth elements. The nitrates stem from the process used which is disclosed below. The other rare-earth elements are very often associated with cerium in the ores from which cerium is extracted and consequently also in solution S which is described below. The total amount of impurities is generally lower than 0.50% by weight, more particularly lower than 0.25% by weight, even lower than 0.20% by weight. The amounts of impurities are determined by well-known analytical techniques used in chemistry, such as microanalysis, X-ray fluorescence, Inductively Coupled Plasma Mass Spectrometry or inductively coupled plasma atomic emission spectroscopy.

The cerium oxide particles exhibit:
a specific surface area (BET) after ageing at 800° C. for 16 hours, under a gaseous atmosphere containing 10% by volume of O₂, 10% by volume of H₂O and the balance of N₂, of at least 75 m²/g, more particularly of at least 76 m²/g, even more particularly of at least 77 m²/g;

or
a specific surface area (BET) after ageing at 700° C. for 16 hours, under a gaseous atmosphere containing 10% by volume of O₂, 10% by volume of H₂O and the balance of N₂, of at least 97 m²/g, more particularly of at least 98 m²/g, even more particularly of at least 99 m²/g.

The cerium oxide particles are also characterized by the specific surface areas (BET) defined below.

The specific surface area (BET) after ageing at 800° C. for 16 hours, under a gaseous atmosphere containing 10% by volume of O₂, 10% by volume of H₂O and the balance of N₂, may be at most 80 m²/g. The specific surface area (BET) after ageing at 800° C. for 16 hours, under a gaseous atmosphere containing 10% by volume of O₂, 10% by volume of H₂O and the balance of N₂, may be between 75 and 80 m²/g, more particularly between 76 and 80 m²/g, even more particularly between 77 and 80 m²/g.

The specific surface area (BET) after ageing at 700° C. for 16 hours, under a gaseous atmosphere containing 10% by volume of O₂, 10% by volume of H₂O and the balance of N₂, may be at least 91 m²/g, more particularly at least 95 m²/g, even more particularly at least 97 m²/g, even more particularly at least 98 m²/g, even more particularly at least 99 m²/g.

The specific surface area (BET) after ageing at 700° C. for 16 hours, under a gaseous atmosphere containing 10% by volume of O₂, 10% by volume of H₂O and the balance of N₂, may be at most 102 m²/g, more particularly at most 100 m²/g. The specific surface area (BET) after ageing at 700° C. for 16 hours, under a gaseous atmosphere containing 10% by volume of O₂, 10% by volume of H₂O and the balance of N₂, may be between 91 and 102 m²/g, more particularly between 95 and 102 m²/g, even more particularly between 97 and 102 m²/g, even more particularly between 98 and 102 m²/g, even more particularly between 99 and 102 m²/g.

The specific surface area (BET) after ageing at 900° C. for 16 hours, under a gaseous atmosphere containing 10% by volume of O₂, 10% by volume of H₂O and the balance of N₂, may be at least 39, more particularly at least 45 m²/g.

The specific surface area (BET) after ageing at 900° C. for 16 hours, under a gaseous atmosphere containing 10% by volume of O₂, 10% by volume of H₂O and the balance of N₂, may be at most 50 m²/g. The specific surface area (BET) after ageing at 900° C. for 16 hours, under a gaseous atmosphere containing 10% by volume of O₂, 10% by volume of H₂O and the balance of N₂, may be between 39 and 50 m²/g, more particularly between 45 and 50 m²/g.

The specific surface area (BET) after calcination in air at 900° C. for 4 hours may be at least 65 m²/g, more particularly at least 67 m²/g. The specific surface area (BET) after calcination in air at 900° C. for 4 hours may be at most 75 m²/g.

The specific surface area (BET) after calcination in air at 900° C. for 24 hours, may be between 40 and 60 m²/g, more particularly between 40 and 55 m²/g.

The cerium oxide particles usually exhibit a mean size D50 between 0.2 μm and 10.0 μm. D50 is more particularly between 0.5 μm and 5.0 μm, even more particularly between 0.5 μm and 3.0 μm or between 1.0 μm and 3.0 μm. D50 may also be comprised between 0.5 μm and 1.8 μm, more particularly between 0.5 μm and 1.5 μm.

The cerium oxide particles may exhibit a D10 between 0.05 μm and 4.0 μm, more particularly between 0.1 μm and 2.0 μm. The cerium oxide particles may exhibit a D90 between 1.0 μm and 18.0 μm, more particularly between 1.5 μm and 8.0 μm, even more particularly between 2.0 μm and 5.0 μm.

D10, D50 and D90 (in μm) have the usual meaning used in statistics. Dn (n=10, 50 or 90) represents the particle size such that n % of the particles is less than or equal to the said size. D50 corresponds to the median value of the distribution. These parameters are determined from a distribution of size of the particles (in volume) obtained with a laser diffraction particle size analyzer. The appliance LA-920 of HORIBA, Ltd. may be used. Conditions disclosed in the examples may apply.

The invention also relates to cerium oxide particles exhibiting an improved reducibility, notably as defined in claim 12. Indeed, after calcination in air at a temperature of 900° C. for 4 hours, these particles are characterized by a reducibility rate r_{600° C.} between 8.0% and 12.0%, more particularly between 8.0% and 10.0%.

After calcination in air at a temperature of 900° C. for 4 hours, the cerium oxide particles may exhibit a reducibility rate r_{900° C.} between 20.0% and 25.0%, more particularly between 22.0% and 25.0%.

After calcination in air at a temperature of 900° C. for 4 hours, the cerium oxide particles may exhibit a reducibility rate r_{400° C.} between 1.5% and 2.0%, more particularly between 1.5% and 1.8%.

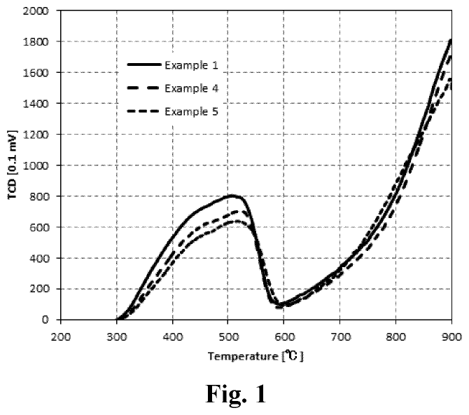

The reducibility rates and the volumes of hydrogen consumed are determined from a TPR curve obtained by temperature programmed reduction (more details about this technique used to characterize catalysts may be found in “Thermal Methods”, chapter 18 of “Characterization of solid materials and heterogeneous catalysts”, Adrien Mekki-Berrada, isbn 978-3-527-32687-7 or in “Temperature programmed reduction and sulphiding”, chapter 11 of “An integrated approach to homogeneous, heterogeneous and industrial catalysis”, 1993, isbn 978-0-444-89229-4). The method consists in measuring the consumption of hydrogen as a function of temperature of a sample which is being heated under a flow of a reducing atmosphere composed of hydrogen (10.0 vol %) diluted in argon (90.0 vol %). The hydrogen consumption is measured with a conductivity thermal detector (TCD) while the sample is heated in a controlled manner from the ambiant temperature to 900° C. under said reducing atmosphere. The measurement can be performed with a Hemmi Slide Rule TP-5000 appliance. The TPR curve gives the intensity of the signal (y axis) of the TCD as a function of the temperature of the sample (x axis). The TPR curve is the curve from 50° C. to 900° C. Examples of TPR curves are given on FIG. 1.

The reducibility rates envisioned in the present application are given by the following formulas:

red_{900° C.}=V_{H2 from 50° C. to 900° C.}/V_{theoretical}×100 (Ia)

red_{600° C.}=V_{H2 from 50° C. to 600° C.}/V_{theoretical}×100 (Ib)

red_{400° C.}=V_{H2 from 50° C. to 400° C.}/V_{theoretical}×100 (Ic)

wherein:
V_{H2 from 50° C. to 900° C.} corresponds to the volume of hydrogen consumed by the cerium oxide between 50° C. and 900° C.;
V_{H2 from 50° C. to 600° C.} corresponds to the volume of hydrogen consumed by the cerium oxide between 50° C. and 600° C.;
V_{H2 from 50° C. to 400° C.} corresponds to the volume of hydrogen consumed by the cerium oxide between 50° C. and 400° C.;
V_{theoretical} corresponds to the theoretical amount of hydrogen that would be consumed by cerium oxide if it were fully reduced. Theoretically, 1 mol of Ce would consume ½ mol of H₂. Of course, in formulas (Ia), (Ib) and (Ic), all volumes are given under the same conditions of pressure and temperature.

The present invention also concerns a method for preparing cerium oxide particles, more particularly the cerium oxide particles described above, as defined in claims 15-23. This method comprises the following steps:

(a) an aqueous solution S comprising nitrates of Ce^{IV} and Ce^{III} is heated at a temperature between 90° C. and 140° C., the aqueous solution being characterized by a Ce^{IV}/total Ce molar ratio of at least 90.0%, more particularly of at least 94.0%, in order to obtain a suspension comprising a liquid medium and a precipitate;

(b) the liquid of the suspension obtained at the end of step (a) is partially removed and water, preferably deionized water, is added;

(c) the mixture obtained at the end of step (b) is heated at a temperature between 100° C. and 180° C., more particularly between 100° C. and 140° C., wherein the mixture being heated is characterized by a molar ratio α=Ce^{III} in solution/total Ce which is strictly less than 6.0%;

(d) a basic compound is added to the suspension obtained at the end of step (c) so as to obtain a pH of at least 8.0;

(e) the liquid of the suspension obtained at the end of step (d) is partially removed;

(f) the suspension obtained at the end of step (e) is heated at a temperature comprised between 60° C. and 180° C., more particularly between 100° C. and 140° C.;

(g) an organic texturing agent is added to the suspension obtained at the end of step (f);

(h) the solid separated from the suspension obtained at the end of step (g) is calcined under air.

The method for preparing the cerium oxide of the invention involves the use of an aqueous solution S comprising nitrates of Ce^{IV} and Ce^{III}. The aqueous solution S is characterized by a molar ratio Ce^{IV}/total Ce of at least 90.0%, more particularly of at least 94.0% (total Ce=Ce^{IV}+Ce^{III}). The molar ratio Ce^{IV}/total Ce may be between 90.0% and 99.9%, more particularly between 94.0% and 99.9%. Measurement of the quantities of Ce^{III} and Ce^{IV} may be performed according to analytical techniques known to the skilled person (see e.g. “Ultraviolet Spectrophotometric Determination of Cerium (III)” of Greenhaus et al., Analytical Chemistry 1957, Vol. 29, N° 10).

The cerium nitrate used to prepare solution S may result from the dissolution of a cerium compound, such as cerium hydroxide, with nitric acid. It is advantageous to use a salt of cerium with a purity of at least 99.5%, more particularly of at least 99.9%. The cerium salt solution may be an aqueous ceric nitrate solution. This solution is obtained by reaction of nitric acid with an hydrated ceric oxide prepared conventionally by reaction of a solution of a cerous salt and of an aqueous ammonia solution in the presence of aqueous hydrogen peroxide to convert Ce^{III} cations into Ce^{IV} cations. It is also particularly advantageous to use a ceric nitrate solution obtained according to the method of electrolytic oxidation of a cerous nitrate solution as disclosed in FR 2570087. A solution of ceric nitrate obtained according to the teaching of FR 2570087 may exhibit an acidity of around 0.6N.

The aqueous solution S may exhibit a total concentration Ce^{III}+Ce^{IV} between 10 g/L and 150 g/L expressed in terms of cerium oxide. For instance, a concentration of 225 g/L of cerium nitrate corresponds to 100 g/L of CeO₂. The aqueous solution is usually acid. The amount of H⁺ in the aqueous solution S may be from 0.01 and 1.0 N. The aqueous solution S contains Ce^{IV}, Ce^{III}, H⁺ and NO₃⁻. It may be obtained by mixing the appropriate quantities of nitrate solutions of Ce^{IV} and Ce^{III} and by optionally adjusting the acidity. Examples of aqueous solutions S are disclosed in examples 1-3.

In step (a), the aqueous solution S is heated at a temperature between 90° C. and 140° C., more particularly between 90° C. and 110° C., in order to obtain a suspension comprising a liquid medium and a precipitate. Without being bound by any theory, it is believed that the obtained precipitate is in the form of cerium hydroxide. The duration of the heat treatment is usually between 10 minutes and 5 hours, preferably between 10 minutes and 2 hours, more preferably between 10 minutes and 60 minutes. Without wishing to be bound by any particular theory, the function of this heating step is to trigger a precipitation of a cerium-containing solid. The conditions of example 1 (100° C.; 30 min) may be used.

In step (b), the liquid of the suspension obtained at the end of step (a) is partially removed and water, preferably deionized water, is added. Removal of the liquid may be carried out, for example, by Nutsche filter method, centrifuging, filter pressing.

The liquid may also be conveniently removed by leaving the solid settle and by removal of the liquid on the top. This technique of leaving the solid settle and removing the liquid was applied in the examples 1-3. Similarly to what is disclosed in the examples 1-3, the following conditions may apply for step (b): the liquid of the suspension obtained at the end of step (a) is partially removed and water, preferably deionized water, is added, wherein the removal of liquid is performed after leaving the solid settle, the quantity of liquid removed being between 50% and 90%, more particularly between 60% and 80%, even more particularly between 70% and 80%, of the quantity of liquid present in the tank. This technique of leaving the solid settle and of removing the liquid is a convenient technique because there is no need to add any filter. Of course, the time needed to leave the solid settle in the bottom of the tank is variable and depends in particular on the size of the particles. The time needed should be such that the solid has settled enough in the tank so that the removal of liquid does not remove too much of solid to maintain a high yield of step (b).

Alternatively, step (b) may be performed by adding water, preferably deionized water. The addition of water makes it possible to decrease the concentration of the anions present in the liquid medium.

The amount of liquid removed may be such that the decrease ratio R is between 10% and 90%, more particularly between 35% and 45%, R being defined by the following equation:

R=[anions] at the end of step (b)/[anions] at the end of step (a)[anions]being the concentration of the anions expressed in mol/L.

As the aqueous solution S contains substantially only nitrates as anions, R may conveniently be calculated by the following equation:

R=(F/G)/(D/E)×100

wherein:
D is the amount of NO₃⁻ (mol) at the end of step (a);
E is the volume (liter) of liquid at the end of step (a);
F is the amount of NO₃⁻ (mol) at the end of step (b);
G is the volume (liter) of liquid at the end of step (b).

F=D×removal ratio of the liquid medium

D may be estimated by the following equation:

D=A/172.12×[B/100×4+(100−B)/100×3]+C

wherein:
A is the amount of cerium cations in terms of CeO₂ (gram);
B is the percentage of tetravalent cerium cations per total cerium cations;
C is the quantity of nitrates (mol) other than the nitrates of Ce(NO₃)₃ and Ce(NO₃)₄.

A, B and C can be deduced from analysis of the aqueous solution S. An alternative method to determine D and R is to analyze the amount of the nitrate anions in the liquid medium with well-known analytical techniques such as ionic chromatography or adsorptiometry.

In step (c), the mixture obtained at the end of step (b) is heated at a temperature between 100° C. and 180° C., more particularly between 100° C. and 140° C. The conditions of example 1 (120° C.; 2 h) may be used. Ce(NO₃)₃ may optionally be added to the mixture before being heated. The mixture that is heated is characterized by a controlled amount of Ce^{III} in solution. Indeed, the molar ratio α=Ce^{III} in solution/total Ce needs to be strictly less than 6.0% (<6.0%). Total Ce is defined as the total amount of cerium (mol) present in the mixture whatever its form (e.g. ion, hydroxide, oxide). Moreover, it is expected that the resistance to ageing in hydrothermal conditions at 700° C. depends on this molar ratio. The molar ratio α is therefore preferably less than or equal to 3.0% 3.0%), more particularly less than or equal to 2.5% 2.5%). a is generally higher than or equal to 0.1%.

The duration of the heat treatment in step (c) is usually between 10 minutes and 48 hours, preferably between 1 hour and 3 hours.

In step (d), a basic compound is added to the suspension obtained at the end of step (c) so as to obtain a pH of at least 8.0, more particularly a pH between 8.0 and 9.5. This basic compound may be for example sodium hydroxide, potassium hydroxide, an aqueous ammonia solution, ammonia gas, or mixtures thereof. Ammonia solution is preferred as it is used conveniently and it provides ammonium nitrate as an effluent. An aqueous solution of ammonia with a concentration between 10 and 12 mol/L may conveniently be used. The function of the basic compound is to help precipitate the Ce^{III} cations which are still present in solution.

In step (e), the liquid of the suspension obtained at the end of step (d) is partially removed. Removal of the liquid may be carried out, for example, by Nutsche filter method, centrifuging or filter pressing.

As in the examples, the liquid may also conveniently be removed by leaving the solid settle followed by removal of the liquid on the top. This technique of leaving the solid settle and removing the liquid was applied in the examples 1-3. Similarly to what is disclosed in the examples 1-3, the following conditions are applied for step (e): the liquid of the suspension obtained at the end of step (d) is partially removed, wherein the removal of liquid is performed after leaving the solid settle, the quantity of liquid removed being between 20% and 60%, more particularly between 40% and 60%, of the quantity of liquid present in the tank. This technique of leaving the solid settle and of removing the liquid is a convenient technique because there is no need to add any filter. Of course, the time needed to leave the solid settle in the bottom of the tank is variable and depends in particular on the size of the particles. The time needed should be such that the solid has settled enough in the tank so that the removal of liquid does not remove too much of solid to maintain a high yield of step (e).

The amount of liquid removed may be such that the decrease ratio R′ is between 5% and 70%, more particularly between 45% and 55%, R′ being defined by the following equation:

R′=[total amount of ions (mol) at the end of step (e)/total amount of Ce (mol) at the end of step (e)]/[total amount of ions (mol) at the end of step (d)/total amount of Ce (mol)at the end of step (d)]

The total amount of Ce corresponds to the Ce present in the mixture at the end of step (d) or step (e) present in the mixture whatever its form. The cerium may be present in the form of an hydroxide (e.g. Ce^{III}(OH)₃ and/or Ce^{VI}(OH)₄) and/or oxyhydroxide (e.g. Ce^{VI}O₂₋ₓH₂O).

The ions that are present at the end of step (d) or step (e) are the following ones: NO₃⁻, OH⁻ and the cation(s) associated to the basic compound(s) that has/have been added. These cations may be Na⁺, K⁺ or NH₄⁺. R′ may be also calculated by a mass balance and/or by analytical methods.

In step (f), the suspension obtained at the end of step (e) is heated at a temperature between 60° C. and 180° C., more particularly between 100° C. and 140° C. The duration of the heat treatment in step (f) is usually between 10 minutes and 5 hours, preferably between 30 min and 2 hours. The conditions of example 1 (120° C.; 1 h) may be used.

In step (g), an organic texturing agent (or “template agent”) is added to the suspension obtained in the preceding step (f). An organic texturing agent usually refers to an organic compound, such as a surfactant, able to control or modify the mesoporous structure of the cerium oxide. “Mesoporous structure” basically describes a structure which specifically comprises pores with an average diameter between 2 and 50 nm, described by the term “mesopores”. Typically, these structures are amorphous or crystalline compounds in which the pores are generally distributed in random fashion, with a very wide pore-size distribution.

The organic texturing agent may be added directly or indirectly. It can be added directly to the suspension. It can also be first added in a composition, for instance comprising a solvent of the organic texturing agent, and said composition being then added to the suspension.

The amount of organic texturing agent added, expressed as percentage by weight of additive relative to the weight of CeO₂, is generally between 5% and 100%, more particularly between 15% and 60%, preferably between 20% to 30%. The amount may be as in example 1 (texturing agent/CeO₂₌₂₅% by weight).

The organic texturing agent is preferably chosen in the group consisting of: anionic surfactants, nonionic surfactants, polyethylene glycols, carboxylic acids and their salts, and surfactants of the carboxymethylated fatty alcohol ethoxylate type. With regard to the organic texturing agent, reference may be made to the teaching of application WO-98/45212 and the surfactants described in this document may be used.

As surfactants of anionic type, mention may be made of ethoxycarboxylates, ethoxylated fatty acids, sarcosinates, phosphate esters, sulfates such as alcohol sulfates, alcohol ether sulfates and sulfated alkanolamide ethoxylates, and sulfonates such as sulfosuccinates, and alkylbenzene or alkylnapthalene sulfonates.

As nonionic surfactants, mention may be made of acetylenic surfactants, alcohol ethoxylates, alkanolamides, amine oxides, ethoxylated alkanolamides, long-chain ethoxylated amines, copolymers of ethylene oxide/propylene oxide, sorbitan derivatives, ethylene glycol, propylene glycol, glycerol, polyglyceryl esters and ethoxylated derivatives thereof, alkylamines, alkylimidazolines, ethoxylated oils and alkylphenol ethoxylates. Mention may in particular be made of the products sold under the brands Igepal®, Dowanol®, Rhodamox® and Alkamide®.

With regard to the carboxylic acids, it is in particular possible to use aliphatic monocarboxylic or dicarboxylic acids and, among these, more particularly saturated acids. Fatty acids and more particularly saturated fatty acids may also be used. Mention may thus in particular be made of formic acid, acetic acid, propionic acid, butyric acid, isobutyric acid, valeric acid, caproic acid, caprylic acid, capric acid, lauric acid, myristic acid and palmitic acid. As dicarboxylic acids, mention may be made of oxalic acid, malonic acid, succinic acid, glutaric acid, adipic acid, pimelic acid, suberic acid, azelaic acid and sebacic acid. Salts of the carboxylic acids may also be used, in particular the ammonium.

The organic texturing agent may more particularly be lauric acid or ammonium laurate.

Finally, it is possible to use a surfactant which is selected from those of the carboxymethylated fatty alcohol ethoxylate type.

The expression “product of the carboxymethylated fatty alcohol ethoxylate type” is intended to mean products consisting of ethoxylated or propoxylated fatty alcohols comprising a —CH₂—COOH group at the end of the chain.

These products may correspond to the formula:

R₁—O—(CR₂R₃—CR₄R₅—O)ₙ—CH₂—COOH

in which R₁ denotes a saturated or unsaturated carbon-based chain of which the length is generally at most 22 carbon atoms, preferably at least 12 carbon atoms; R₂, R₃, R₄ and R₅ may be identical and may represent hydrogen or else R₂ may represent an alkyl group such as a CH₃ group and R₃, R₄ and R₅ represent hydrogen; n is a non-zero integer that may be up to 50 and more particularly between 5 and 15, these values being included. It will be noted that a surfactant may consist of a mixture of products of the formula above for which R₁ may be saturated or unsaturated, respectively, or alternatively products comprising both —CH₂—CH₂—O— and —C(CH₃)=CH₂—O— groups.

Steps (a)-(g) may be performed in any vessel without critical limitation, and either a sealed vessel or an open vessel may be used. Specifically, an autoclave reactor may preferably be used. All steps (a)-(g) may be performed in the same vessel.

In step (h), the solid separated from the suspension obtained at the end of step (g) is calcined under air. Calcination is performed at a temperature of at least 300° C. The temperature may be between 300° C. and 900° C., more particularly between 300° C. and 450° C. The duration of the calcination may suitably be determined depending on the temperature, and may preferably be between 1 and 20 hours. The conditions of example 1 (400° C., 10 hours) may be used.

Step (h) may optionally be followed by step (i) which consists in sieving the cerium oxide particles obtained at the end of step (h). The benefits of step (i) is to remove the largest particles from the cerium oxide particles and also to improve the flowability of the powder.

The invention also concerns cerium oxide particles susceptible to be obtained by this process. The conditions of examples 1-3 may be used to prepare the cerium oxide particles of the invention. The cerium oxide particles of the present invention may preferably be prepared by the method according to the present invention.

The present invention also concerns a catalytic composition comprising the cerium oxide as defined above. Thus, the cerium oxide particles of the invention may be used for the preparation of a catalytic composition. An example of catalytic composition comprising the cerium oxide may be found in EP 3070074.

A catalytic composition comprising the cerium oxide may be used in the field of depollution. The invention also relates to a process of treatment of an exhaust gas released by the internal combustion engine of a vehicle, comprising contacting the exhaust gas with the cerium oxide of the invention or with a catalytical composition comprising said cerium oxide. The process aims at reducing the pollutants present in the exhaust gas. Said catalytic composition generally comprises the cerium oxide and at least one inorganic oxide other than cerium oxide.

The inorganic oxide may be selected from the group consisting of alumina optionally stabilized by lanthanum and/or praseodymium; ceria; magnesia; silica; titania; zirconia; tantalum oxide; molybdenum oxide; tungsten oxide; and composite oxides thereof. The composite oxide may be silica-alumina, magnesia-alumina, ceria-zirconia or alumina-ceria-zirconia. The inorganic oxide may be more particularly selected from the group consisting of magnesia-alumina, alumina, or aluminum stabilized by lanthanum and/or praseodymium. An example of inorganic oxide is alumina stabilized with 1.0% to 6.0 weight % of lanthanum, this proportion of lanthanum being expressed in lanthanum oxide.

The catalytic composition is generally applied on a thermally inert support. Such support is well known to the skilled person and may be selected in the group consisting of alumina, titanium oxide, cerium oxide, zirconium oxide, silica, spinels, zeolites, silicates, crystalline silicoaluminum phosphates or crystalline aluminum phosphates.

The following examples are included to illustrate the invention.

Experimental Part

After the calcination of step (h) (of after step (i) if any), the cerium oxide particles are tested as they are without any additional treatment.

Specific Surface Areas

The specific surface areas (BET) by adsorption of N₂ are determined automatically on a Flowsorb II 2300 or a Macsorb analyzer model 1-1220 (Mountech Co., LTD.). Prior to any measurement, the samples are carefully degassed to desorb any adsorbed volatile species such as H₂O. To do so, the samples may be heated at 200° C. for 2 hours in a stove, then at 300° C. for 15 min in the cell.

Measurement of D10, D50 and D90

These parameters are determined from a distribution of size of the particles (in volume) obtained with a laser diffraction particle size analyzer. Appliance LA-920 of HORIBA was used. The particles are dispersed in water.

Temperature Programmed Reduction (TPR)

TPR curves are obtained with a temperature programmed desorption analyzer manufactured by Hemmi Slide Rule Co., LTD. with a carrier gas containing by volume 90% argon and 10% hydrogen, at a gas flow rate of 30 ml/min. The heating rate of the sample (0.5 g) is 13.3° C./min. The TPR curves are obtained on samples which have been calcined under air at 900° C. for 4 hours.

Hydrothermal Conditions at 800° C./16 h

The cerium oxide particles are aged at 800° C. for 16 hours under a gaseous atmosphere containing 10% by volume of O₂, 10% by volume of H₂O and the balance of N₂. The specific surface is then measured in accordance with the BET measurement method explained in the above.

Other Conditions

The cerium oxide particles have also been aged at 700° C. and 900° C. for 16 hours under a gaseous atmosphere containing 10% by volume of O₂, 10% by volume of H₂O and the balance of N₂.

### Example 1 (According to the Invention)

10 kg of a ceric nitrate solution in terms of CeO₂ containing 94.3 mol % tetravalent cerium ions was measured out, and adjusted to a total amount of 200 L with deionized water. This corresponds to 9430 g of Ce^{IV} and 570 g of CO (expressed in terms of CeO₂). The ceric nitrate solution was obtained according to FR 2570087. The obtained solution S was heated to 100° C., maintained at this temperature for 30 minutes, and allowed to cool down to the room temperature, to thereby obtain a suspension.

After the solid has settled in the tank, the mother liquor was removed on the top (quantity of removed liquid=156 L; this corresponds roughly to 78% of the liquid present in the tank). The total volume of the medium was then adjusted to 200 L by addition of deionized water. Calculations lead to a decrease ratio R of 38%. Indeed, from formula: A=10 000 g; B=94.3 mol %; C=20.68 mol (nitrates other than nitrates from Ce(NO₃)₃ and Ce(NO₃)₄)=>one can deduce D=249.8 mol. Here, E=G=200 L. The mother liquor removed was analyzed and exhibits a concentration in nitrates of 1 mol/L. One can then deduce F=249.8 mol-156 (L)×1 (mol/L)=93.8 mol. R=(93.8/200)/(249.8/200)×100=38%.

After the removal of the mother liquor, a solution of trivalent CO cations in a form of nitrate (Ce(NO₃)₃) was added (437.9 g in terms of oxide) so as to control the amount of trivalent Ce^{III} cations in the solution to a value α=Ce^{III}/total Ce=5.7 mol %.

Then the cerium suspension was maintained at 120° C. for 2 hours, allowed to cool, and neutralized to pH 8.9 with aqueous ammonia.

After the solid has settled in the tank, the mother liquor was removed on the top (quantity of removed liquid: 100 L; this corresponds roughly to 50% of the liquid present in the tank). Calculations lead to a decrease ratio R′ of 50%. The slurry was then maintained at 120° C. for 1 hour, and allowed to cool. To the slurry resulting from the heating, 2.5 kg of lauric acid (texturing agent/CeO₂=25% by weight) was added, and stirred for 60 minutes.

The obtained slurry was subjected to solid-liquid separation through a filter pressing to obtain a filter cake. The cake was then calcined in the air at 400° C. for 10 hours to obtain the cerium oxide particles.

### Example 2 (According to the Invention)

Cerium oxide particles were prepared exactly in the same way as in example 1 except that:
10 kg of a ceric nitrate solution in terms of CeO₂ containing 92.9 mol % instead of 94.3 mol % tetravalent cerium ions was measured out;
the quantity of mother liquor removed=150 L (calculations lead to a decrease of R=41% instead of 38%);
a solution of trivalent Ce^{III} cations was not added after the mother liquor was removed so that the molar α=ratio Ce^{III}/total Ce was decreased to 2.0 mol %.

### Example 3 (According to the Invention)

50 g of a ceric nitrate solution in terms of CeO₂ containing 94.1 mol % tetravalent cerium ions was measured out, and adjusted to a total amount of 1 L with deionized water. The obtained solution S was heated to 100° C., maintained at this temperature for 30 minutes, and allowed to cool down to the room temperature, to thereby obtain a cerium suspension.

After the solid has settled in the tank, the mother liquor was removed from the cerium suspension thus obtained (quantity of mother liquor removed: 0.75 L). Then the total volume was adjusted by the addition of 1 L of deionized water. Calculations lead to a decrease ratio R of 41%. The molar ratio Ce^{III}/total Ce (α) was decreased to 1.6 mol %.

Then the cerium suspension was maintained at 120° C. for 2 hours, allowed to cool, and neutralized to pH 8.5 with aqueous ammonia. After the solid has settled in the tank, 0.5 L of the mother liquor was removed from the basic slurry thus obtained. Calculations lead to a decrease ratio R′ of 50%. The slurry was then maintained at 100° C. for 1 hour, and allowed to cool. To the slurry resulting from the heating, 11.8 g of lauric acid was added (texturing agent/CeO₂=25% by weight), and stirred for 60 minutes.

The obtained slurry was subjected to solid-liquid separation through a Nutsche filter to obtain a filter cake. The cake was calcined in the air at 400° C. for 10 hours to obtain the cerium oxide particles.

### Example 4 (Comparative)

Cerium oxide particles were prepared in accordance with the method of example 1 disclosed in WO 2016/075177. 50 g of a ceric nitrate solution in terms of CeO₂ containing not less than 90 mol % tetravalent cerium cations was measured out, and adjusted to a total amount of 1 L with deionized water. The obtained solution was heated to 100° C., maintained at this temperature for 30 minutes, and allowed to cool down to 25° C., to thereby obtain a suspension.

After the mother liquor was removed from the cerium suspension thus obtained, the total volume was adjusted to 1 L with deionized water; concentration of anions was hence decreased by 44%, in comparison with anions comprised in the liquid medium after heating.

Then the cerium suspension was maintained at 120° C. for 2 hours, allowed to cool, and neutralized to pH 8.5 with aqueous ammonia. To the slurry resulting from the neutralization, 12.5 g of lauric acid was added, and stirred for 60 minutes. The obtained slurry was subjected to solid-liquid separation through a Nutsche filter to obtain a filter cake. The cake was calcined in the air at 300° C. for 10 hours to obtain particles of cerium oxide.

### Example 5 (Comparative)

A ceric oxide powder was prepared in accordance with the method disclosed as example 1 of WO 2017/198738. 50 g of a ceric nitrate solution in terms of CeO₂ containing not less than 90 mol % tetravalent cerium cations was measured out, and adjusted to a total amount of 1 L with deionized water. The obtained solution was heated to 100° C., maintained at this temperature for 30 minutes, and allowed to cool down to 25° C., to thereby obtain a cerium suspension.

After the mother liquor was removed from the cerium suspension thus obtained, the total volume was adjusted to 1 L with deionized water; concentration of anions is hence decreased by 44%, in comparison with anions comprised in the liquid medium after heating. After the removal of the mother liquor, a solution of trivalent Ce^{III} cations in a form of nitrate (Ce(NO₃)₃) was added so as to control the amount of trivalent Ce^{III} cations to a value Celli/total Ce (a)=6.0 mol %.

Then the cerium suspension was maintained at 120° C. for 2 hours, allowed to cool, and neutralized to pH 8.5 with aqueous ammonia. The obtained solution was heated to 120° C., maintained at this temperature for 1 hour, and allowed to cool down to 25° C., thereby obtaining a slurry. The obtained slurry was subjected to solid-liquid separation through a Nutsche filter to obtain a filter cake. The cake was calcined in the air at 400° C. for 10 hours to obtain cerium oxide powder.

### Example 6 (Comparative)

A ceric oxide powder was prepared in accordance with the method disclosed as example 2 of WO 2017/198738. A cerium oxide powder was prepared in the same way as in example 5 except that after the thermal aging at the temperature of 120° C. for 1 hour, the obtained slurry was allowed to cool down to 40° C., and then, lauric acid (12.5 g) was added to the slurry.

### Example 7 (Comparative)

A ceric oxide powder was prepared in accordance with the method disclosed as example 3 of WO 2017/198738. A cerium oxide powder was prepared in the same way as in Example 6 except that the amount of trivalent CO cations based on the total amount of cerium was controlled to be 8.0 mol %, instead of 6.0 mol %.

Table 1 and Table 2 provide a comparison between cerium oxide particles prepared according to this application on the one hand and cerium oxide particles prepared according to WO 2016/075177 (ex. 4) and WO 2017/198738 on the other hand (ex. 5-7).

TABLE 1

| | | | | comparative examples | | | |
|---|---|---|---|---|---|---|---|
| | according to the | | | 4 | | | |
| | invention | | | according to WO | 5 | 6 | 7 |
| Examples | 1 | 2 | 3 | 2016/075177 | according to WO 2017/198738 | | |
| D50 (μm) | 1.4 | 2.3 | 2.2 | 2.8 | 4.5 | 1.2 | 3.6 |
| D10 (μm) | 0.9 | 1.5 | 1.3 | 1.8 | 2.8 | 0.7 | 2.1 |
| D90 (μm) | 2.2 | 3.8 | 3.7 | 4.6 | 7.0 | 1.9 | 5.8 |
| S_{BET} 700° C./16 | 91 | 100 | 99 | / | 92 | 89 | 84 |
| h/hydrothermal | | | | | | | |
| conditions | | | | | | | |
| S_{BET} 800° C./16 | 78 | 76 | 75 | 72 | 65 | 65 | 68 |
| h/hydrothermal | | | | | | | |
| conditions | | | | | | | |
| S_{BET} 900° C./16 | 45 | 39 | / | 37 | 37 | 41 | 45 |
| h/hydrothermal | | | | | | | |
| conditions | | | | | | | |
| S_{BET} 900° C./4 | 71 | 67 | 68 | 63 | 57 | 64 | 63 |
| h/air | | | | | | | |
| S_{BET} 900° C./24 | 52 | 43 | 42 | 41 | 43 | 49 | 48 |
| h/air | | | | | | | |

S_{BET}: specific surface areas (BET) in m²/g

As can be seen in Table 1, the cerium oxide particles according to the invention exhibit a better specific surface after treatment under hydrothermal conditions. They also exhibit a better thermal resistance at 900° C. for 4 hours.

TABLE 2

| | according to the | | | | | | |
|---|---|---|---|---|---|---|---|
| | invention | | | comparative examples | | | |
| Examples | 1 | 2 | 3 | 4 | 5 | 6 | 7 |
| r_{400° C.} (%) | 1.8 | 1.5 | 1.5 | 1.3 | 1.1 | 1.3 | 1.2 |
| r_{600° C.} (%) | 9.8 | 8.5 | 8.8 | 8.0 | 7.5 | 7.8 | 7.9 |
| r_{900° C.} (%) | 24.5 | 22.7 | 23.5 | 20.5 | 21.9 | 19.8 | 20.3 |

As can be seen in Table 2, the cerium oxide particles according to the invention also exhibit better reducibilities.

This is also visible on FIG. 1 which provides the TPR curves for the cerium oxides of ex. 1, ex. 4 and ex. 5. It is visible that the cerium oxide of ex. 1 consumes more hydrogen than the two other oxides of ex. 4 and ex. 5, in particular between 50° C. and 600° C.

1. Cerium oxide particles exhibiting:
a specific surface area (BET) after ageing at 800° C. for 16 hours, under a gaseous atmosphere containing 10% by volume of O₂, 10% by volume of H₂O and the balance of N₂, of at least 75 m²/g; or
a specific surface area (BET) after ageing at 700° C. for 16 hours, under a gaseous atmosphere containing 10% by volume of O₂, 10% by volume of H₂O and the balance of N₂, of at least 97 m²/g.

2. Cerium oxide particles according to claim 1, exhibiting a specific surface area (BET) after ageing at 800° C. for 16 hours, under a gaseous atmosphere containing 10% by volume of O₂, 10% by volume of H₂O and the balance of N₂, between 75 and 80 m²/g.

3. Cerium oxide particles according to claim 1, exhibiting a specific surface area (BET) after ageing at 700° C. for 16 hours, under a gaseous atmosphere containing 10% by volume of O₂, 10% by volume of H₂O and the balance of N₂.

4. Cerium oxide particles according to claim 1, exhibiting a specific surface area (BET) after ageing at 700° C. for 16 hours, under a gaseous atmosphere containing 10% by volume of O₂, 10% by volume of H₂O and the balance of N₂, between 97 and 102 m²/g.

5. Cerium oxide particles according to one of the preceding claims, exhibiting a specific surface area (BET) after ageing at 900° C. for 16 hours, under a gaseous atmosphere containing 10% by volume of O₂, 10% by volume of H₂O and the balance of N₂, of at least 39 m²/g.

6. Cerium oxide particles according to claim 1, exhibiting a specific surface area (BET) after ageing at 900° C. for 16 hours, under a gaseous atmosphere containing 10% by volume of O₂, 10% by volume of H₂O and the balance of N₂, of at most 50 m²/g.

7. Cerium oxide particles according to claim 1, exhibiting a specific surface area (BET) after calcination in air at 900° C. for 4 hours of at least 65 m²/g.

8. Cerium oxide particles according to claim 1, exhibiting a specific surface area (BET) after calcination in air at 900° C. for 4 hours, of at most 75 m²/g.

9. Cerium oxide particles according to claim 1, exhibiting a specific surface area (BET) after calcination in air at 900° C. for 24 hours, between 40 and 60 m²/g.

10. Cerium oxide particles according to claim 1, exhibiting a mean size D50 between 0.2 μm and 10.0 μm, D50 corresponding to the median value of a distribution of size of the particles (in volume) obtained with a laser diffraction particle size analyzer.

11. Cerium oxide particles according to claim 1, exhibiting a reducibility rate r_{900° C.} comprised between 20.0% and 25.0%, after calcination in air at 900° C. for 4 hours, r_{900° C.} being defined by:
red_{900° C.}=V_{H2 from 50° C. to 900° C.}/V_{theoretical}×100 (Ia)
wherein:
V_{H2 from 50° C. to 900° C.} corresponds to the volume of hydrogen consumed by the cerium oxide between 50° C. and 900° C.;
V_{theoretical} corresponds to the theoretical amount of hydrogen consumed by cerium oxide.

12. Cerium oxide particles exhibiting a reducibility rate r_{900° C.} comprised between 20.0% and 25.0%, after calcination in air at 900° C. for 4 hours, r_{900° C.} being defined by:
red_{900° C.}=V_{H2 from 50° C. to 900° C.}/V_{theoretical}×100 (Ia)
wherein:
V_{H2 from 50° C. to 900° C.} corresponds to the volume of hydrogen consumed by the cerium oxide between 50° C. and 900° C.;
V_{theoretical} corresponds to the theoretical amount of hydrogen consumed by cerium oxide.

13. Cerium oxide particles according to claim 1, exhibiting a reducibility rate r_{600° C.} comprised between 8.0% and 12.0%, after calcination in air at 900° C. for 4 hours, r_{600° C.} being defined by:
red_{600° C.}=V_{H2 from 50° C. to 600° C.}/V_{theoretical}×100 (Ib)
wherein:
V_{H2 from 50° C. to 600° C.} corresponds to the volume of hydrogen consumed by the cerium oxide between 50° C. and 600° C.;
V_{theoretical} corresponds to the theoretical amount of hydrogen consumed by cerium oxide.

14. Cerium oxide particles according to claim 1, exhibiting a reducibility rate r_{400° C.} comprised between 1.5% and 2.0%, after calcination in air at 900° C. for 4 hours, r_{400° C.} being defined by:
red_{400° C.}=V_{H2 from 50° C. to 400° C.}/V_{theoretical}×100 (Ic)
wherein:
V_{H2 from 50° C. to 400° C.} corresponds to the volume of hydrogen consumed by the cerium oxide between 50° C. and 400° C.;
V_{theoretical} corresponds to the theoretical amount of hydrogen consumed by cerium oxide.

15. Method A method for preparing cerium oxide particles, the method comprising the following steps:
(a) heating an aqueous solution S comprising nitrates of Ce^{IV} and Ce^{III} at a temperature between 90° C. and 140° C., the aqueous solution being characterized by a Ce^{IV}/total Ce molar ratio of at least 90.0%, in order to obtain a suspension comprising a liquid medium and a precipitate;
(b) partially removing the liquid of the suspension obtained at the end of step (a) and adding water;
(c) heating the mixture obtained at the end of step (b) is heated at a temperature between 100° C. and 180° C., wherein the mixture being heated is characterized by a molar ratio α=Ce^{III} in solution/total Ce which is strictly less than 6.0%;
(d) adding a basic compound to the suspension obtained at the end of step (c) so as to obtain a pH of at least 8.0;
(e) partially removing the liquid of the suspension obtained at the end of step (d) ;
(f) heating the suspension obtained at the end of step (e) at a temperature between 60° C. and 180° C., more particularly between 100° C. and 140° C.;
(g) adding an organic texturing agent to the suspension obtained at the end of step (f);
(h) calcining the solid separated from the suspension obtained at the end of step (g) under air.

16.-23. (canceled)

24. Catalytic A catalytic composition comprising the cerium oxide according to claim 1 and at least one inorganic oxide other than cerium oxide.

25. A process for treatment of an exhaust gas released by the internal combustion engine of a vehicle, the process comprising contacting the exhaust gas with the cerium oxide according to claim 1.

26. A process for treatment of an exhaust gas released by the internal combustion engine of a vehicle, the process comprising contacting the exhaust gas with the catalytic composition of claim 24.
